(19) United States
(12) Patent Application Publication
(10) Pub. No.: US 2026/0161398 A1
(43) Pub. Date: Jun. 11, 2026

(54) Apparatus And Method For Efficient Execution Of Wide Vector Load Operations

(71) Applicants: Mark DECHENE, Hillsboro, OR (US); Patrick NDOUNIAMA, Portland, OR (US); Meenakshi MARATHE, Hillsboro, OR (US); Thomas MULLINS, Sunnyvale, CA (US); Paula PETRICA, Portland, OR (US)

(72) Inventors: Mark DECHENE, Hillsboro, OR (US); Patrick NDOUNIAMA, Portland, OR (US); Meenakshi MARATHE, Hillsboro, OR (US); Thomas MULLINS, Sunnyvale, CA (US); Paula PETRICA, Portland, OR (US)

(21) Appl. No.: 18/971,329

(22) Filed: Dec. 6, 2024

(51) Int. Cl. G06F 9/30; G06F 9/38; G06F 12/0875

(52) U.S. Cl. CPC G06F 9/30036; G06F 9/3016; G06F 9/3802; G06F 12/0875; G06F 2212/452

(57) ABSTRACT

An apparatus and method for efficiently executing wide vector load instructions. For example, one example method comprises: fetching a vector load instruction having one or more fields to indicate data to be loaded having a width greater than a data pipe width of a cache subsystem; allocating multiple data pipes of the cache subsystem to concurrently provide multiple corresponding portions of the data, wherein the multiple data pipes are to be allocated from multiple slices of the plurality of slices or from a single slice of the plurality of slices; aligning the multiple corresponding portions of the data within a register or other memory having a size greater than or equal to the width of the data; and providing the data to execution circuitry over an interconnect having a width greater than or equal to the width of the aligned data.

### BACKGROUND

### Field of the Invention

This invention relates generally to the field of computer processors. More particularly, the invention relates to an apparatus and method for efficient execution of wide vector load operations.

### Description of the Related Art

The current x86 instruction set architecture (ISA) supports up to 512-bit vector loads, which are implemented natively on processor hardware. This typically requires increased data bus sizes throughout each core to match the data width of the largest supported load size, which can result in significant die area increases, particularly in wide execution machines.

### BRIEF DESCRIPTION OF THE DRAWINGS

A better understanding of the present invention can be obtained from the following detailed description in conjunction with the following drawings, in which:

FIG. 1 illustrates an example computer system architecture.

FIG. 2 illustrates a processor comprising a plurality of cores.

FIG. 3A illustrates a plurality of stages of a processing pipeline.

FIG. 3B illustrates details of one embodiment of a core.

FIG. 4 illustrates execution circuitry in accordance with one embodiment.

FIG. 5 illustrates one embodiment of a register architecture.

FIG. 6 illustrates one example of an instruction format.

FIG. 7 illustrates addressing techniques in accordance with one embodiment.

FIG. 8 illustrates one embodiment of an instruction prefix.

FIGS. 9A-D illustrate embodiments of how the R, X, and B fields of the prefix are used.

FIGS. 10A-B illustrate examples of a second instruction prefix.

FIG. 11 illustrates payload bytes of one embodiment of an instruction prefix.

FIG. 12 illustrates instruction conversion and binary translation implementations.

FIG. 13 illustrates a processor architecture in accordance with some embodiments of the invention.

FIG. 14 illustrates primary and secondary pipes concurrently operable to perform a wide vector load instruction.

FIG. 15 illustrates various scenarios in which different portions of data to be loaded are handled by different pipes, potentially in different cache slices.

FIG. 16 illustrates a method in accordance with embodiments of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

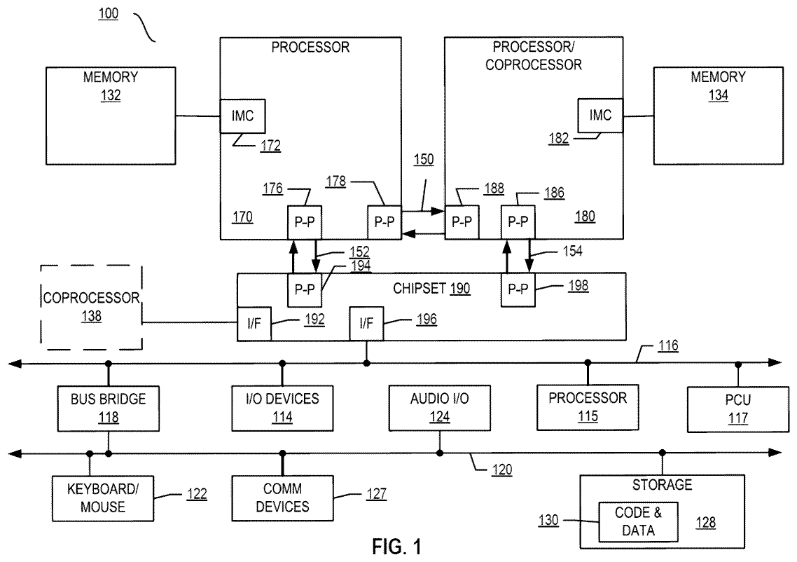

FIG. 1 illustrates embodiments of an exemplary system. Multiprocessor system 100 is a point-to-point interconnect system and includes a plurality of processors including a first processor 170 and a second processor 180 coupled via a point-to-point interconnect 150. In some embodiments, the first processor 170 and the second processor 180 are homogeneous. In some embodiments, first processor 170 and the second processor 180 are heterogenous.

Processors 170 and 180 are shown including integrated memory controller (IMC) units circuitry 172 and 182, respectively. Processor 170 also includes as part of its interconnect controller units point-to-point (P-P) interfaces 176 and 178; similarly, second processor 180 includes P-P interfaces 186 and 188. Processors 170, 180 may exchange information via the point-to-point (P-P) interconnect 150 using P-P interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a chipset 190 via individual P-P interconnects 152, 154 using point to point interface circuits 176, 194, 186, 198. Chipset 190 may optionally exchange information with a coprocessor 138 via a high-performance interface 192. In some embodiments, the coprocessor 138 is a special-purpose processor, such as, for example, a high-throughput MIC processor, a network or communication processor, compression engine, graphics processor, GPGPU, embedded processor, or the like.

A shared cache (not shown) may be included in either processor 170, 180 or outside of both processors, yet connected with the processors via P-P interconnect, such that either or both processors' local cache information may be stored in the shared cache if a processor is placed into a low power mode.

Chipset 190 may be coupled to a first interconnect 116 via an interface 196. In some embodiments, first interconnect 116 may be a Peripheral Component Interconnect (PCI) interconnect, or an interconnect such as a PCI Express interconnect or another I/O interconnect. In some embodiments, one of the interconnects couples to a power control unit (PCU) 117, which may include circuitry, software, and/or firmware to perform power management operations with regard to the processors 170, 180 and/or co-processor 138. PCU 117 provides control information to a voltage regulator to cause the voltage regulator to generate the appropriate regulated voltage. PCU 117 also provides control information to control the operating voltage generated. In various embodiments, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other embodiments, power management operations to be performed by PCU 117 may be implemented externally to a processor, such as by way of a separate power management integrated circuit (PMIC) or another component external to the processor. In yet other embodiments, power management operations to be performed by PCU 117 may be implemented within BIOS or other system software.

Various I/O devices 114 may be coupled to first interconnect 116, along with an interconnect (bus) bridge 118 which couples first interconnect 116 to a second interconnect 120. In some embodiments, one or more additional processor(s) 115, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 116. In some embodiments, second interconnect 120 may be a low pin count (LPC) interconnect. Various devices may be coupled to second interconnect 120 including, for example, a keyboard and/or mouse 122, communication devices 127 and a storage unit circuitry 128. Storage unit circuitry 128 may be a disk drive or other mass storage device which may include instructions/code and data 130, in some embodiments. Further, an audio I/O 124 may be coupled to second interconnect 120. Note that other architectures than the point-to-point architecture described above are possible. For example, instead of the point-to-point architecture, a system such as multiprocessor system 100 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

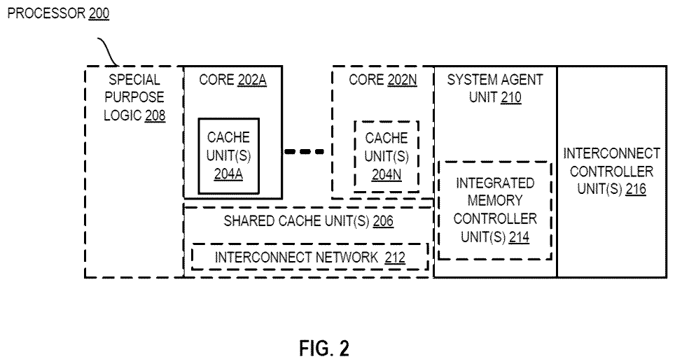

FIG. 2 illustrates a block diagram of embodiments of a processor 200 that may have more than one core, may have an integrated memory controller, and may have integrated graphics. The solid lined boxes illustrate a processor 200 with a single core 202A, a system agent 210, a set of one or more interconnect controller units circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interconnect controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

A memory hierarchy includes one or more levels of cache unit(s) circuitry 204(A)-(N) within the cores 202(A)-(N), a set of one or more shared cache units circuitry 206, and external memory (not shown) coupled to the set of integrated memory controller units circuitry 214. The set of one or more shared cache units circuitry 206 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 212 interconnects the special purpose logic 208 (e.g., integrated graphics logic), the set of shared cache units circuitry 206, and the system agent unit circuitry 210, alternative embodiments use any number of well-known techniques for interconnecting such units. In some embodiments, coherency is maintained between one or more of the shared cache units circuitry 206 and cores 202(A)-(N).

In some embodiments, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous or heterogeneous in terms of architecture instruction set; that is, two or more of the cores 202(A)-(N) may be capable of executing the same instruction set, while other cores may be capable of executing only a subset of that instruction set or a different instruction set.

### Exemplary Core Architectures

### In-Order and Out-of-Order Core Block Diagram

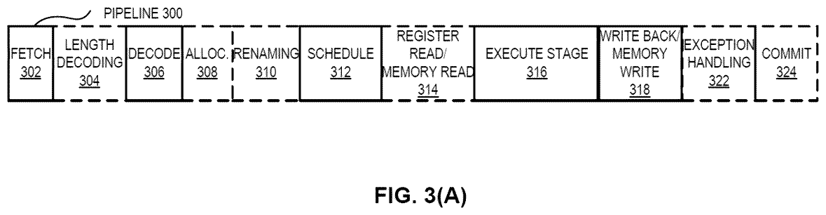

FIG. 3(A) is a block diagram illustrating both an exemplary in-order pipeline and an exemplary register renaming, out-of-order issue/execution pipeline according to embodiments of the invention. FIG. 3(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 3(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3(A), a processor pipeline 300 includes a fetch stage 302, an optional length decode stage 304, a decode stage 306, an optional allocation stage 308, an optional renaming stage 310, a scheduling (also known as a dispatch or issue) stage 312, an optional register read/memory read stage 314, an execute stage 316, a write back/memory write stage 318, an optional exception handling stage 322, and an optional commit stage 324. One or more operations can be performed in each of these processor pipeline stages. For example, during the fetch stage 302, one or more instructions are fetched from instruction memory, during the decode stage 306, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 306 and the register read/memory read stage 314 may be combined into one pipeline stage. In one embodiment, during the execute stage 316, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 300 as follows: 1) the instruction fetch 338 performs the fetch and length decoding stages 302 and 304; 2) the decode unit circuitry 340 performs the decode stage 306; 3) the rename/allocator unit circuitry 352 performs the allocation stage 308 and renaming stage 310; 4) the scheduler unit(s) circuitry 356 performs the schedule stage 312; 5) the physical register file(s) unit(s) circuitry 358 and the memory unit circuitry 370 perform the register read/memory read stage 314; the execution cluster 360 perform the execute stage 316; 6) the memory unit circuitry 370 and the physical register file(s) unit(s) circuitry 358 perform the write back/memory write stage 318; 7) various units (unit circuitry) may be involved in the exception handling stage 322; and 8) the retirement unit circuitry 354 and the physical register file(s) unit(s) circuitry 358 perform the commit stage 324.

FIG. 3(B) shows processor core 390 including front-end unit circuitry 330 coupled to an execution engine unit circuitry 350, and both are coupled to a memory unit circuitry 370. The core 390 may be a reduced instruction set computing (RISC) core, a complex instruction set computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front end unit circuitry 330 may include branch prediction unit circuitry 332 coupled to an instruction cache unit circuitry 334, which is coupled to an instruction translation lookaside buffer (TLB) 336, which is coupled to instruction fetch unit circuitry 338, which is coupled to decode unit circuitry 340. In one embodiment, the instruction cache unit circuitry 334 is included in the memory unit circuitry 370 rather than the front-end unit circuitry 330. The decode unit circuitry 340 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 340 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 390 includes a microcode ROM (not shown) or other medium that stores microcode for certain macroinstructions (e.g., in decode unit circuitry 340 or otherwise within the front end unit circuitry 330). In one embodiment, the decode unit circuitry 340 includes a micro-operation (micro-op) or operation cache (not shown) to hold/cache decoded operations, micro-tags, or micro-operations generated during the decode or other stages of the processor pipeline 300. The decode unit circuitry 340 may be coupled to rename/allocator unit circuitry 352 in the execution engine unit circuitry 350.

The execution engine circuitry 350 includes the rename/allocator unit circuitry 352 coupled to a retirement unit circuitry 354 and a set of one or more scheduler(s) circuitry 356. The scheduler(s) circuitry 356 represents any number of different schedulers, including reservations stations, central instruction window, etc. In some embodiments, the scheduler(s) circuitry 356 can include arithmetic logic unit (ALU) scheduler/scheduling circuitry, ALU queues, arithmetic generation unit (AGU) scheduler/scheduling circuitry, AGU queues, etc. The scheduler(s) circuitry 356 is coupled to the physical register file(s) circuitry 358. Each of the physical register file(s) circuitry 358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 358 includes vector registers unit circuitry, writemask registers unit circuitry, and scalar register unit circuitry. These register units may provide architectural vector registers, vector mask registers, general-purpose registers, etc. The physical register file(s) unit(s) circuitry 358 is overlapped by the retirement unit circuitry 354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 354 and the physical register file(s) circuitry 358 are coupled to the execution cluster(s) 360. The execution cluster(s) 360 includes a set of one or more execution units circuitry 362 and a set of one or more memory access circuitry 364. The execution units circuitry 362 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 356, physical register file(s) unit(s) circuitry 358, and execution cluster(s) 360 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 364). It should also be understood that where separate pipelines are used, one or more of these pipelines may be out-of-order issue/execution and the rest in-order.

In some embodiments, the execution engine unit circuitry 350 may perform load store unit (LSU) address/data pipelining to an Advanced Microcontroller Bus (AHB) interface (not shown), and address phase and writeback, data phase load, store, and branches.

The set of memory access circuitry 364 is coupled to the memory unit circuitry 370, which includes data TLB unit circuitry 372 coupled to a data cache circuitry 374 coupled to a level 2 (L2) cache circuitry 376. In one exemplary embodiment, the memory access units circuitry 364 may include a load unit circuitry, a store address unit circuit, and a store data unit circuitry, each of which is coupled to the data TLB circuitry 372 in the memory unit circuitry 370. The instruction cache circuitry 334 is further coupled to a level 2 (L2) cache unit circuitry 376 in the memory unit circuitry 370. In one embodiment, the instruction cache 334 and the data cache 374 are combined into a single instruction and data cache (not shown) in L2 cache unit circuitry 376, a level 3 (L3) cache unit circuitry (not shown), and/or main memory. The L2 cache unit circuitry 376 is coupled to one or more other levels of cache and eventually to a main memory.

The core 390 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 390 includes logic to support a packed data instruction set extension (e.g., AVX1, AVX2), thereby allowing the operations used by many multimedia applications to be performed using packed data.

### Exemplary Execution Unit(s) Circuitry

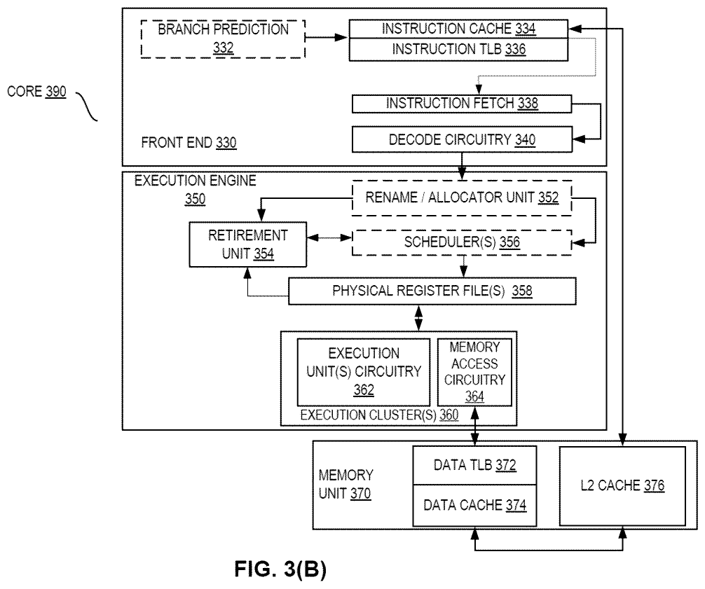

FIG. 4 illustrates embodiments of execution unit(s) circuitry, such as execution unit(s) circuitry 362 of FIG. 3(B). As illustrated, execution unit(s) circuitry 362 may include one or more ALU circuits 401, vector/SIMD unit circuits 403, load/store unit circuits 405, and/or branch/jump unit circuits 407. ALU circuits 401 perform integer arithmetic and/or Boolean operations. Vector/SIMD unit circuits 403 perform vector/SIMD operations on packed data (such as SIMD/vector registers). Load/store unit circuits 405 execute load and store instructions to load data from memory into registers or store from registers to memory. Load/store unit circuits 405 may also generate addresses. Branch/jump unit circuits 407 cause a branch or jump to a memory address depending on the instruction. Floating-point unit (FPU) circuits 409 perform floating-point arithmetic. The width of the execution unit(s) circuitry 362 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

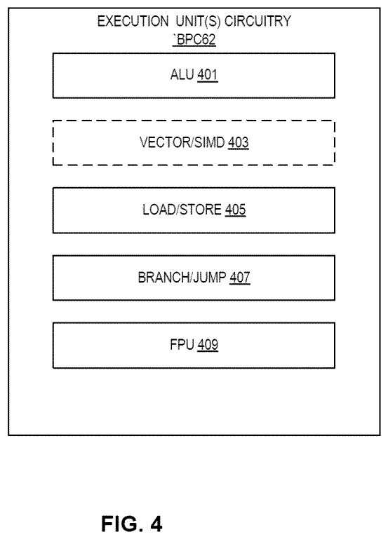

FIG. 5 is a block diagram of a register architecture 500 according to some embodiments. As illustrated, there are vector/SIMD registers 510 that vary from 128-bit to 1,024 bits width. In some embodiments, the vector/SIMD registers 510 are physically 512-bits and, depending upon the mapping, only some of the lower bits are used. For example, in some embodiments, the vector/SIMD registers 510 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 500 includes writemask/predicate registers 515. For example, in some embodiments, there are 8 writemask/predicate registers (sometimes called k0 through k7) that are each 16-bit, 32-bit, 64-bit, or 128-bit in size. Writemask/predicate registers 515 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 515 corresponds to a data element position of the destination. In other embodiments, the writemask/predicate registers 515 are scalable and consists of a set number of enable bits for a given vector element (e.g., 8 enable bits per 64-bit vector element).

The register architecture 500 includes a plurality of general-purpose registers 525. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 500 includes scalar floating-point register 545 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 540 (e.g., EFLAGS, RFLAGS, etc.) store status and control information for arithmetic, compare, and system operations. For example, the one or more flag registers 540 may store condition code information such as carry, parity, auxiliary carry, zero, sign, and overflow. In some embodiments, the one or more flag registers 540 are called program status and control registers.

Segment registers 520 contain segment points for use in accessing memory. In some embodiments, these registers are referenced by the names CS, DS, SS, ES, FS, and GS.

Machine specific registers (MSRs) 535 control and report on processor performance. Most MSRs 535 handle system-related functions and are not accessible to an application program. Machine check registers 560 consist of control, status, and error reporting MSRs that are used to detect and report on hardware errors.

One or more instruction pointer register(s) 530 store an instruction pointer value. Control register(s) 555 (e.g., CR0-CR4) determine the operating mode of a processor (e.g., processor 170, 180, 138, 115, and/or 200) and the characteristics of a currently executing task. Debug registers 550 control and allow for the monitoring of a processor or core's debugging operations.

Memory management registers 565 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

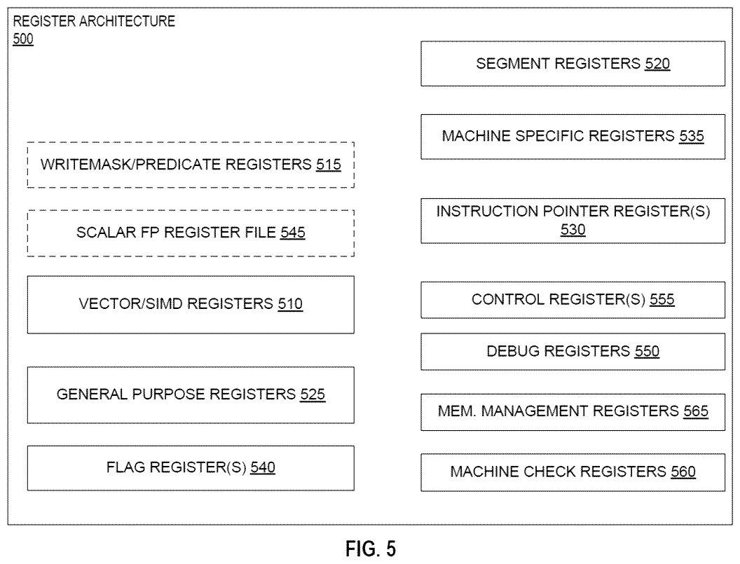

FIG. 6 illustrates embodiments of an instruction format. As illustrated, an instruction may include multiple components including, but not limited to, one or more fields for: one or more prefixes 601, an opcode 603, addressing information 605 (e.g., register identifiers, memory addressing information, etc.), a displacement value 607, and/or an immediate 609. Note that some instructions utilize some or all of the fields of the format whereas others may only use the field for the opcode 603. In some embodiments, the order illustrated is the order in which these fields are to be encoded, however, it should be appreciated that in other embodiments these fields may be encoded in a different order, combined, etc.

The prefix(es) field(s) 601, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 603 is used to at least partially define the operation to be performed upon a decoding of the instruction. In some embodiments, a primary opcode encoded in the opcode field 603 is 1, 2, or 3 bytes in length. In other embodiments, a primary opcode can be a different length. An additional 3-bit opcode field is sometimes encoded in another field.

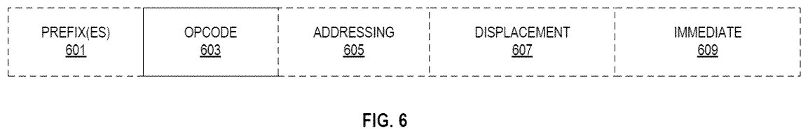

The addressing field 605 is used to address one or more operands of the instruction, such as a location in memory or one or more registers. FIG. 7 illustrates embodiments of the addressing field 605. In this illustration, an optional ModR/M byte 702 and an optional Scale, Index, Base (SIB) byte 704 are shown. The ModR/M byte 702 and the SIB byte 704 are used to encode up to two operands of an instruction, each of which is a direct register or effective memory address. Note that each of these fields are optional in that not all instructions include one or more of these fields. The MOD R/M byte 702 includes a MOD field 742, a register field 744, and R/M field 746.

The content of the MOD field 742 distinguishes between memory access and non-memory access modes. In some embodiments, when the MOD field 742 has a value of b11, a register-direct addressing mode is utilized, and otherwise register-indirect addressing is used.

The register field 744 may encode either the destination register operand or a source register operand, or may encode an opcode extension and not be used to encode any instruction operand. The content of register index field 744, directly or through address generation, specifies the locations of a source or destination operand (either in a register or in memory). In some embodiments, the register field 744 is supplemented with an additional bit from a prefix (e.g., prefix 601) to allow for greater addressing.

The R/M field 746 may be used to encode an instruction operand that references a memory address, or may be used to encode either the destination register operand or a source register operand. Note the R/M field 746 may be combined with the MOD field 742 to dictate an addressing mode in some embodiments.

The SIB byte 704 includes a scale field 752, an index field 754, and a base field 756 to be used in the generation of an address. The scale field 752 indicates scaling factor. The index field 754 specifies an index register to use. In some embodiments, the index field 754 is supplemented with an additional bit from a prefix (e.g., prefix 601) to allow for greater addressing. The base field 756 specifies a base register to use. In some embodiments, the base field 756 is supplemented with an additional bit from a prefix (e.g., prefix 601) to allow for greater addressing. In practice, the content of the scale field 752 allows for the scaling of the content of the index field 754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 607 provides this value. Additionally, in some embodiments, a displacement factor usage is encoded in the MOD field of the addressing field 605 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 607.

In some embodiments, an immediate field 609 specifies an immediate for the instruction. An immediate may be encoded as a 1-byte value, a 2-byte value, a 4-byte value, etc.

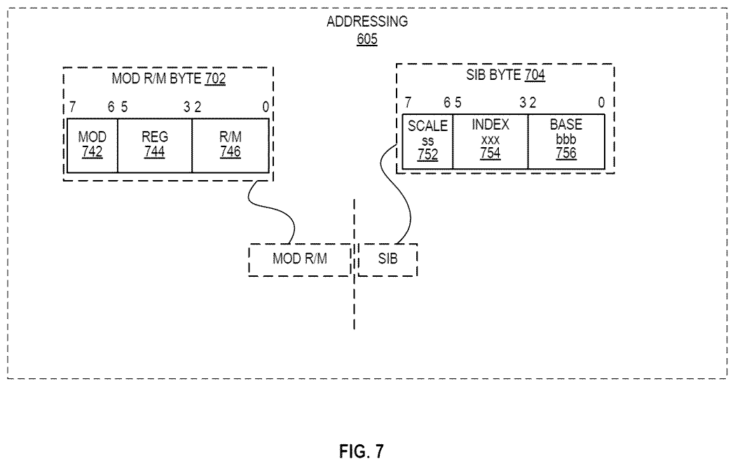

FIG. 8 illustrates embodiments of a first prefix 601(A). In some embodiments, the first prefix 601(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 601(A) may specify up to three registers using 3-bit fields depending on the format: 1) using the reg field 744 and the R/M field 746 of the Mod R/M byte 702; 2) using the Mod R/M byte 702 with the SIB byte 704 including using the reg field 744 and the base field 756 and index field 754; or 3) using the register field of an opcode.

In the first prefix 601(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 744 and MOD R/M R/M field 746 alone can each only address 8 registers.

In the first prefix 601(A), bit position 2 (R) may an extension of the MOD R/M reg field 744 and may be used to modify the ModR/M reg field 744 when that field encodes a general purpose register, a 64-bit packed data register (e.g., a SSE register), or a control or debug register. R is ignored when Mod R/M byte 702 specifies other registers or defines an extended opcode.

Bit position 1 (X) X bit may modify the SIB byte index field 754.

Bit position B (B) B may modify the base in the Mod R/M R/M field 746 or the SIB byte base field 756; or it may modify the opcode register field used for accessing general purpose registers (e.g., general purpose registers 525).

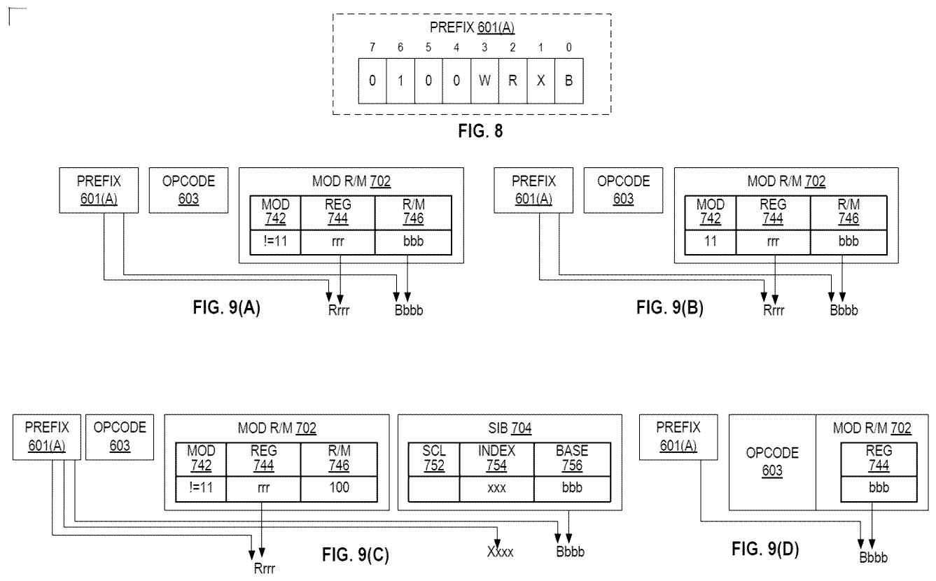

FIGS. 9(A)-(D) illustrate embodiments of how the R, X, and B fields of the first prefix 601(A) are used. FIG. 9(A) illustrates R and B from the first prefix 601(A) being used to extend the reg field 744 and R/M field 746 of the MOD R/M byte 702 when the SIB byte 7 04 is not used for memory addressing. FIG. 9(B) illustrates R and B from the first prefix 601(A) being used to extend the reg field 744 and R/M field 746 of the MOD R/M byte 702 when the SIB byte 7 04 is not used (register-register addressing). FIG. 9(C) illustrates R, X, and B from the first prefix 601(A) being used to extend the reg field 744 of the MOD R/M byte 702 and the index field 754 and base field 756 when the SIB byte 7 04 being used for memory addressing. FIG. 9(D) illustrates B from the first prefix 601(A) being used to extend the reg field 744 of the MOD R/M byte 702 when a register is encoded in the opcode 603.

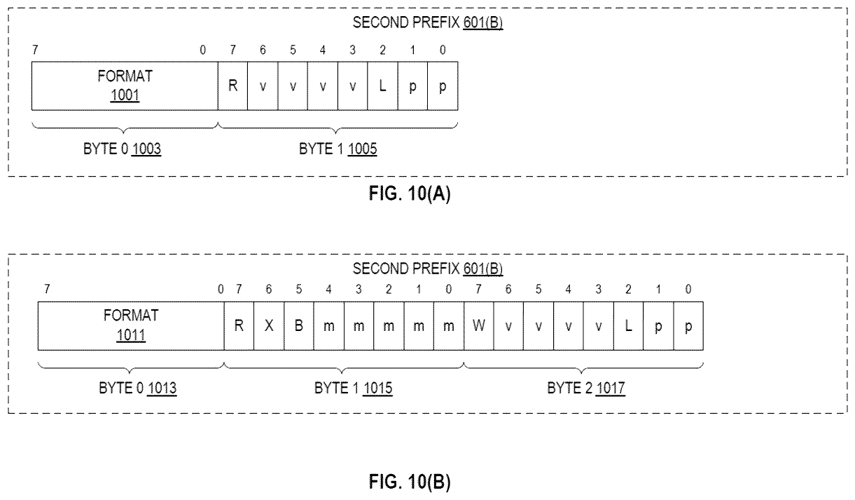

FIGS. 10(A)-(B) illustrate embodiments of a second prefix 601(B). In some embodiments, the second prefix 601(B) is an embodiment of a VEX prefix. The second prefix 601(B) encoding allows instructions to have more than two operands, and allows SIMD vector registers (e.g., vector/SIMD registers 510) to be longer than 64-bits (e.g., 128-bit and 256-bit). The use of the second prefix 601(B) provides for three-operand (or more) syntax. For example, previous two-operand instructions performed operations such as A=A+B, which overwrites a source operand. The use of the second prefix 601(B) enables operands to perform nondestructive operations such as A=B+C.

In some embodiments, the second prefix 601(B) comes in two forms—a two-byte form and a three-byte form. The two-byte second prefix 601(B) is used mainly for 128-bit, scalar, and some 256-bit instructions; while the three-byte second prefix 601(B) provides a compact replacement of the first prefix 601(A) and 3-byte opcode instructions.

FIG. 10(A) illustrates embodiments of a two-byte form of the second prefix 601(B). In one example, a format field 1001 (byte 0 1003) contains the value C5H. In one example, byte 1 1005 includes a “R” value in bit[7]. This value is the complement of the same value of the first prefix 601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746 and the Mod R/M reg field 744 encode three of the four operands. Bits[7:4] of the immediate 609 are then used to encode the third source register operand.

FIG. 10(B) illustrates embodiments of a three-byte form of the second prefix 601(B). in one example, a format field 1011 (byte 0 1013) contains the value C4H. Byte 1 1015 includes in bits[7:5] “R,” “X,” and “B” which are the complements of the same values of the first prefix 601(A). Bits[4:0] of byte 1 1015 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit[7] of byte 2 1017 is used similar to W of the first prefix 601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746, and the Mod R/M reg field 744 encode three of the four operands. Bits[7:4] of the immediate 609 are then used to encode the third source register operand.

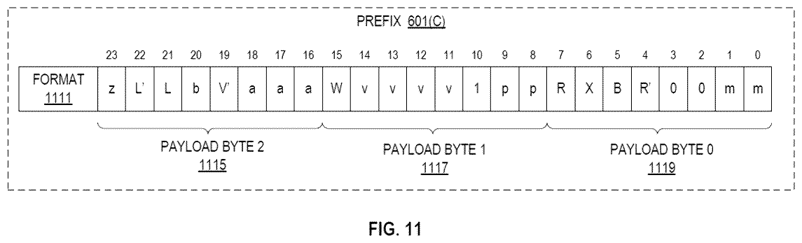

FIG. 11 illustrates embodiments of a third prefix 601(C). In some embodiments, the first prefix 601(A) is an embodiment of an EVEX prefix. The third prefix 601(C) is a four-byte prefix.

The third prefix 601(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 5) or predication utilize this prefix. Opmask register allow for conditional processing or selection control. Opmask instructions, whose source/destination operands are opmask registers and treat the content of an opmask register as a single value, are encoded using the second prefix 601(B).

The third prefix 601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 601(C) is a format field 1111 that has a value, in one example, of 62H. Subsequent bytes are referred to as payload bytes 1115-1119 and collectively form a 24-bit value of P[23:0] providing specific capability in the form of one or more fields (detailed herein).

In some embodiments, P[1:0] of payload byte 1119 are identical to the low two mmmmm bits. P[3:2] are reserved in some embodiments. Bit P[4] (R′) allows access to the high 16 vector register set when combined with P[7] and the ModR/M reg field 744. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 744 and ModR/M R/M field 746. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 601(A) and second prefix 611(B) and may serve as an opcode extension bit or operand size promotion.

P[18:16] specify the index of a register in the opmask (writemask) registers (e.g., writemask/predicate registers 515). In one embodiment of the invention, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in instructions using the third prefix 601(C) are detailed in the following tables.

TABLE 1
32-Register Support in 64-bit Mode

| | | | | | COMMON |
|---|---|---|---|---|---|
| | 4 | 3 | [2:0] | REG. TYPE | USAGES |
| REG | R′ | R | ModR/M | GPR, Vector | Destination |
| | | | reg | | or Source |
| VVVV | V′ | vvvv | | GPR, Vector | 2nd Source |
| | | | | | or Destination |
| RM | X | B | ModR/M | GPR, Vector | 1st Source |
| | | | R/M | | or Destination |
| BASE | 0 | B | ModR/M | GPR | Memory |
| | | | R/M | | addressing |
| INDEX | 0 | X | SIB.index | GPR | Memory |
| | | | | | addressing |
| VIDX | V′ | X | SIB.index | Vector | VSIB memory |
| | | | | | addressing |

TABLE 2
Encoding Register Specifiers in 32-bit Mode

| | | | COMMON |
|---|---|---|---|
| | [2:0] | REG. TYPE | USAGES |
| REG | ModR/M | GPR, Vector | Destination |
| | reg | | or Source |
| VVVV | vvvv | GPR, Vector | 2^{nd} Source |
| | | | or Destination |
| RM | ModR/M | GPR, Vector | 1^{st} Source |
| | R/M | | or Destination |
| BASE | ModR/M | GPR | Memory |
| | R/M | | addressing |
| INDEX | SIB.index | GPR | Memory |
| | | | addressing |
| VIDX | SIB.index | Vector | VSIB memory |
| | | | addressing |

TABLE 3
Opmask Register Specifier Encoding

| | | | COMMON |
|---|---|---|---|
| | [2:0] | REG. TYPE | USAGES |
| REG | ModR/M | k0-k7 | Source |
| | Reg | | |
| VVVV | vvvv | k0-k7 | 2^{nd} Source |
| RM | ModR/M | k0-7 | 1^{st} Source |
| | R/M | | |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

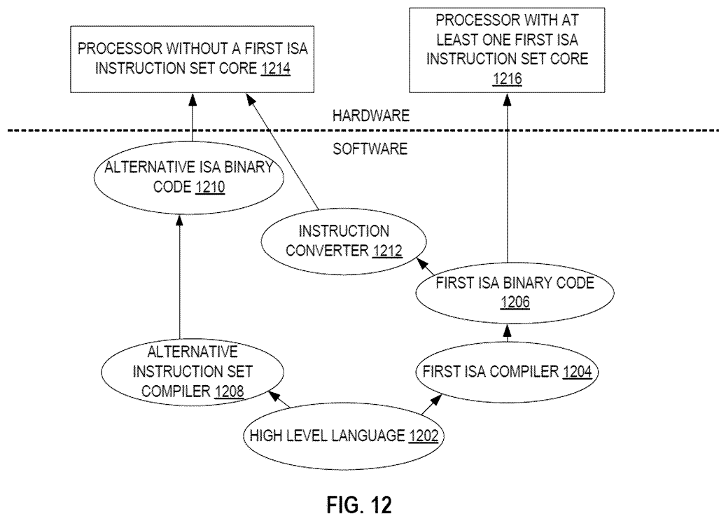

FIG. 12 illustrates a block diagram contrasting the use of a software instruction converter to convert binary instructions in a source instruction set to binary instructions in a target instruction set according to certain implementations. In the illustrated embodiment, the instruction converter is a software instruction converter, although alternatively the instruction converter may be implemented in software, firmware, hardware, or various combinations thereof. FIG. 12 shows a program in a high level language 1202 may be compiled using a first ISA compiler 1204 to generate first ISA binary code 1206 that may be natively executed by a processor with at least one first instruction set core 1216. The processor with at least one first ISA instruction set core 1216 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 1204 represents a compiler that is operable to generate first ISA binary code 1206 (e.g., object code) that can, with or without additional linkage processing, be executed on the processor with at least one first ISA instruction set core 1216.

Similarly, FIG. 12 shows the program in the high level language 1202 may be compiled using an alternative instruction set compiler 1208 to generate alternative instruction set binary code 1210 that may be natively executed by a processor without a first ISA instruction set core 1214. The instruction converter 1212 is used to convert the first ISA binary code 1206 into code that may be natively executed by the processor without a first ISA instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have a first ISA instruction set processor or core to execute the first ISA binary code 1206.

### Apparatus and Method for Efficient Execution of Wide Vector Load Operations

The current x86 instruction set architecture (ISA) supports up to 512-bit vector loads, which are implemented natively on processor hardware. This typically requires increased data bus sizes throughout each core to match the data width of the largest supported load size, which can result in significant die area increases, particularly in wide execution machines.

Previous processor generations have either widened the data bus throughout the processor to match the maximum load size supported (if possible, given the area budget) or by breaking the instruction in the front end of the machine to execute as two separate loads at the cost of lost performance. Some prior implementations also split up the uop in the data cache unit, inserting a bubble in the pipeline to stream the data over multiple cycles over the narrower data bus, again at the cost of increased latency.

In accordance with embodiments of the invention, to support wide vector loads on a data cache unit with multiple data pipes of limited width, the processor schedules wider loads to utilize two side-by-side data pipes, thereby doubling the effective data width supported, with one pipe designated as the primary data pipe and the other pipe designated the secondary data pipe. As used herein, the data pipes are interconnects internal to the cache subsystem. Each wide load may be tracked as a single load in the processor and certain controls and reporting can only occur on the primary data pipe. Some embodiments also provide data rotation for cacheline splits for these wider loads.

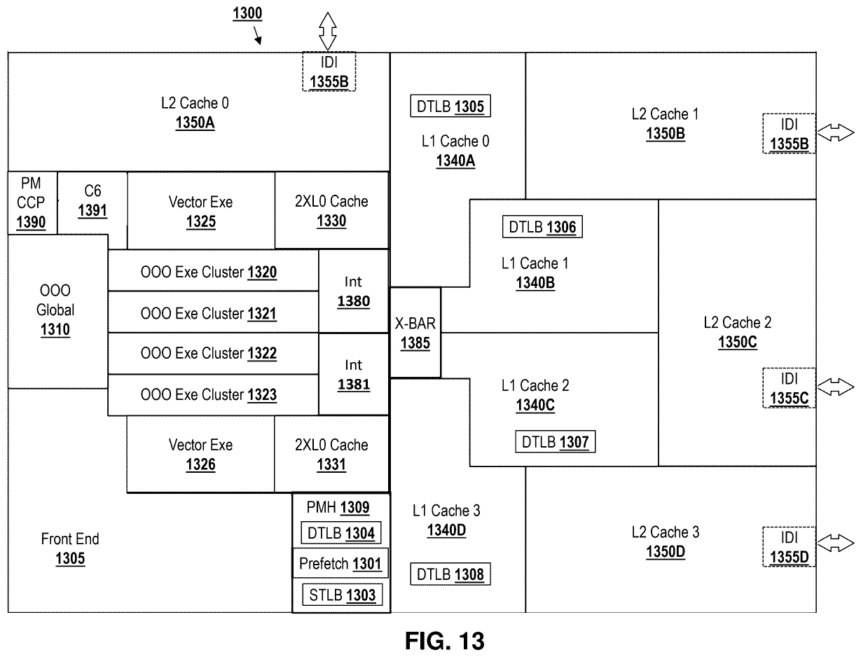

FIG. 13 illustrates an example processor 1300 (or processor tile integrated on the processor package with other processor tiles) on which the embodiments described herein may be implemented. Four out-of-order (OOO) processing clusters 1320-1323 with out-of-order instruction processing and execution circuitry are coupled to a corresponding plurality of L1 cache slices 1340A-D via a crossbar fabric 1385 via one or more respective interfaces 1380-1381. Front end circuitry 1305 performs instruction fetching and scheduling operations to dispatch the instructions to the OOO clusters 1320-1323 and/or global OOO circuitry 1310 which maintains global ordering in operations performed by the OOO clusters 1320-1323 while executing instructions. In certain examples, the OOO clusters 1320-1323 or the front end circuitry 1305 divide an instruction stream into groups of contiguous instructions or “strands,” several of which may be executed simultaneously on separate OOO clusters 1320-1323.

In the illustrated example, the processor includes a memory and cache subsystem comprising the L1 cache slices 1340A-D, as well as a set of L2 cache slices 1350A-D, which include respective in-die interconnects (IDIs) 1355A-D to couple to a next level cache (e.g., an L3 cache or LLC) and/or to a memory controller coupled to a system memory, such as a DDR DRAM memory (not shown). In some implementation, each OOO execution cluster 1323 and vector execution circuit 1325-1326 includes a set of interconnects to couple the OOO execution cluster 1320-1323 to each L1 cache slice 1340A-D (e.g., via the crossbar 1385). In accordance with the embodiments of the invention, the L1 cache slices 1340A-D can allocate multiple data pipes to support wide vector loads, with one pipe designated as the primary data pipe and the other pipe(s) designated the secondary data pipe(s). The OOO execution circuitry 1320-1323 and/or vector execution circuitry 1325-1326 may track the wide load as a single load where control functions and reporting occur on the primary data pipe. Data rotation is also used in some embodiments to properly align the data from the multiple data pipes.

Some processor components use virtual memory addresses which are translated to physical memory addresses via data-side translation lookaside buffers (DTLBs) 1304-1308 and one or more second level TLBs (STLB) 1303. A page miss handler (PMH) 1309 performs page walk operations in response to TLB misses (i.e., when a required virtual-to-physical address translation is not present in one of the TLBs). In some implementations, a primary DTLB 1304 is one of five DTLBs 1304-1308 distributed throughout the processor. In particular, each L1 data cache (D$) slice 1340A-D includes a respective DTLB 1305-1308, which are synchronized with the primary DTLB 1304. For example, the PMH 1309 or other logic may perform synchronization operations in response to TLB updates and invalidations to ensure that all five DTLB 1304-1308 are coherent with each other (i.e., continually updated to store the same set of entries).

Prefetch circuitry 1301 may observe patterns in STLB 1303 hits, learn whether the pattern is sequential or irregular, and manage a pattern table to identify the irregular patterns. When the prefetch circuitry 1301 decides to prefetch a TLB entry from the STLB 1303 to the DTLB 1304, it attempts to read the entry out of the STLB, but if it is not found in the STLB 1303, then the prefetch is dropped (i.e., the prefetch circuitry 1301 does not cause additional page walk operations).

Certain types of instructions may be executed by vector execution circuits 1325-1326, which include parallel execution circuitry for performing vector or tensor operations on vectors and matrices. Vector operations may be performed, for example, to process sets of data elements packed into SIMD/vector registers (e.g., fused multiply-accumulate operations, dot-product operations, etc). Tensor operations may be performed on multi-dimensional data elements (e.g., 2D matrices) packed into tile registers (e.g., groups of vector registers) to perform matrix operations (e.g., such as matrix multiplications described herein).

The other illustrated processor blocks include a power management circuit 1390 for performing power control operations such as voltage and PLL (i.e., frequency) regulation. A C6 circuit 1391 retains the execution state associated with one or more threads, strands, or instructions when one or more of the vector execution circuits 1325-1326 or OOO clusters 1320-1323 enter into a C6 low power state

In some embodiments of the invention, the data path in the vector execution circuitry 1325-1326 and the scheduling logic (e.g., a reservation station (RS)) is increased in the to support wider vector load instructions. To work around the area and routing constraints in the cache subsystem (e.g., the L1 data cache slices 1340A-D), the wider loads are split into half widths and performed side-by-side on two pipes, each connected to a half width (128-bit) data bus. The half width data buses are connected to an aggregator unit that is physically located near the vector execution unit. The aggregator combines the data from both pipes in the correct alignment and sends it over a 256-bit bus to the vector execution circuits 1325-1326, which runs for relatively short distance.

These embodiments may also implement 256-stores in a consistent manner. In particular, the 256-bit stores are cracked by the scheduler (e.g., the reservation station) as two separate 128-bit stores with separate architectural IDs. Without breaking down the 256-bit loads as previously described, the L1 cache slices 1340A-D would need to provide a mechanism to support store-to-load forwarding from two smaller stores to a larger load without incurring any performance impact, which would add considerable logic and timing complexity. By implementing the embodiments of the invention, the two portions of the wider load can independently forward from the two smaller stores with existing per-pipe store-to-load forwarding logic.

### Dual Pipe Load Arbitration

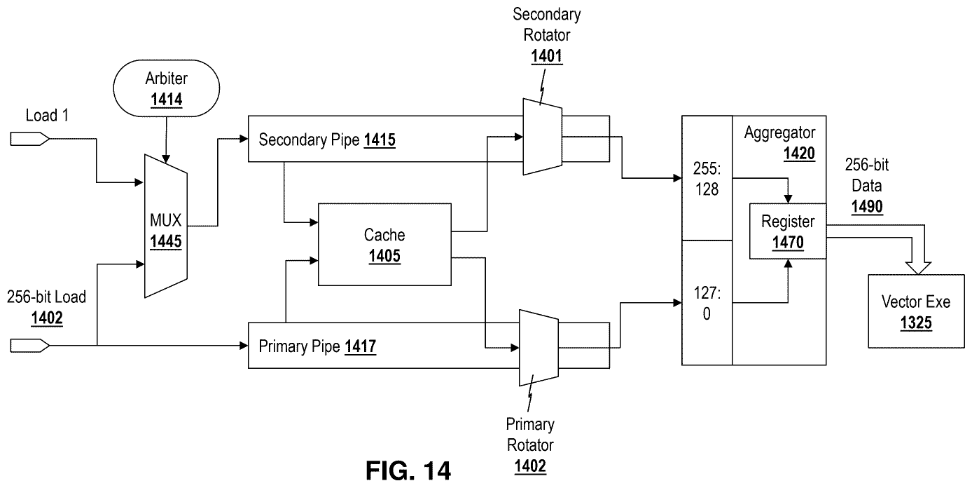

FIG. 14 illustrates an example implementation described with respect to a cache memory 1405 (e.g., a memory of one of the L1 cache slices 1340A-D), including a primary execution pipe 1417 and secondary execution pipe 1416 coupled to an aggregator 1420 which combines the data from the two pipes in a register 1470 or other storage structure. The primary pipe 1417 includes a primary rotator 1402 and the secondary pipe 1415 includes a secondary rotator 1401, each of which rotates the corresponding 128-bit width data as required for combination by the aggregator 1420 to produce the 256-bit width data 1490 in the register 1470.

In operation, on receipt of a load request by the L1 cache 1405, if the load is detected to be of wider size (e.g., 256 bits), the L1 cache 1405 arbitrates for dual cache control pipes 1415, 1417. The execution pipe that maps to the receipt port (i.e., over which the request is received), is designated as the primary pipe 1417 which is used to access the lower half of the load data, while the secondary pipe 1415 is used to access the higher half of the load. In these embodiments, each “pipe” refers to an independent or separately operable N-bit interconnect (e.g., where N=128 in some described embodiments).

In some implementations, each L1 cache 1405 has access to four separate pipes, i.e., pipes 0-3, which can be accessed by loads through arbitration, and a corresponding set of four ports, i.e., ports 0-3, over which requests are received. To simplify the arbitration, the pipe pairing may be fixed. For example, a load which arrives on a port (e.g., port 0) that maps to execution pipe 0, will additionally attempt to acquire access to pipe 1 to communicate the second portion of the load data. Similarly, if the load request arrives on a port (e.g., port 1) that maps to execution pipe 1, it will attempt to acquire access to pipe 0 to communicate the second portion of the load data. When this type of dual pipe load operation is granted access to both pipes 1415, 1417, the relevant portion of the 256-bit payload 1402 is muxed to the secondary pipe 1415 (e.g., by multiplexer 1445).

The dual pipe approach poses timing challenges for critical paths such as the fastest and second fastest alignments for incoming loads to be submitted into the execution pipe. As such, these alignments are excluded for wider loads (e.g., 256-bit loads as described herein). These wider loads arbitrate for the execution pipeline (e.g., through the schedule pipeline of the reservation station). In these embodiments, the schedule pipeline may have a 1 to 1 mapping to the main execution pipes.

When a wider load is scheduled for execution into the schedule pipe, it arbitrates for the primary 1417 and secondary 1415 pair of pipes. An arbiter 1414 determines when the dual pipe configuration is granted. In some embodiments, the arbiter 1414 uses a weighted round robin arbitration protocol. If there is no valid microoperations currently utilizing the pair of pipes 1415, 1417, the dual pipe load configuration can be allocated regardless of the round robin result. To avoid forward progress issues, an oldest load uop will always win the pipe/s it needs. Existing stalling mechanisms in the scheduling pipeline is extended to the dual pipe load arbitration described herein to avoid costly recycle penalties when a single pipe load loses to a dual pipe load, or when the dual pipe load fails to win both pipes. This allows the losing microoperation (e.g., Load 1 in FIG. 14) to make progress after a one cycle stall.

### Address Adjustment

For wider loads to execute as two smaller loads as described herein, embodiments of the invention adjust the start and end linear addresses for the two pipes. For example, the linear address start on the primary pipe 1417 may be the same as the original load and the corresponding linear address end is set by adding 15 bytes to the starting linear address, thereby providing bits [127:0] of the load to the aggregator 1420. Similarly, the linear address start for secondary pipe may be determined by adding 16 bytes to the starting linear address (or 1 byte to the linear address end) of the primary pipe. The linear address end for the secondary pipe 1415 may be kept the same as the linear address end received for the original 256-bit load request, resulting in the secondary pipe 1415 providing bits 256:128 to the aggregator 1420, which combines the two 128-bit portions to transmit the 256-bit data 1490 over the wider (e.g., 256-bit) interconnect to the vector circuitry 1325-1326 (or OOO execution clusters 1320-1323). There are some exceptions for cacheline splits that are explained further below.

### Main Pipe Execution

Once the dual pipe load is allocated, it executes side by side on the two pipes 1415, 1417. Since the load is still treated as a single load outside of the L1 cache 1405, some operations can only be performed from the primary pipe 1417. These operations can include, by way of example and not limitation, page walk operations (e.g., in response to a TLB miss), allocation of a miss buffer, signaling load completions, and reporting fault conditions.

The primary pipe 1417 can signal a load completion only when both pipes 1415, 1417 have completed moving their respective data. If either pipe 1415, 1417 blocks on a resource, the entire load is blocked. If both pipes 1415, 1417 block, but for different reasons, removal of the primary pipe blocking is prioritized over the secondary pipe blocking.

### Data Rotation for Cacheline Splits on Wider Loads

The L1 cache 1405 may be partitioned into four slices 1340A-D as shown in FIG. 13, and the slices may be associated with different addresses, such that the two portions of a cacheline split will land in two different L1 slices 1340A-D. In some embodiments, non-splitting wider loads that don't split across a cacheline boundary may be executed on two pipes 1415, 1417 within the same L1 cache slice. In this case, the primary rotator 1402 in the primary pipe 1417 and the secondary rotator 1401 in the secondary pipe 1415 right shift the corresponding data in to the same register alignment as for any regular load. The aggregator 1420 may be informed that this is a dual pipe wider load so it can correctly place each portion of 128-bit data in the correct position within a 256-bit data register 1470 before transmission to the vector unit 1325.

In some embodiments, for a cacheline split, the secondary rotator 1401 rotates the split high data left by the split low size and pads it with zeros in the least significant bits (LSBs) to reach the 128-bit width. This allows the aggregator 1420 to simply OR the split high data (256:128) with the split low data (127:0) to get the final data 256-bit data 1490 to send to the vector execution circuitry 1325 (or 000 execution cluster). This leads to some special considerations for data rotation for 256-bit cacheline split loads to avoid adding logic and timing complexity to the existing aggregator 1420.

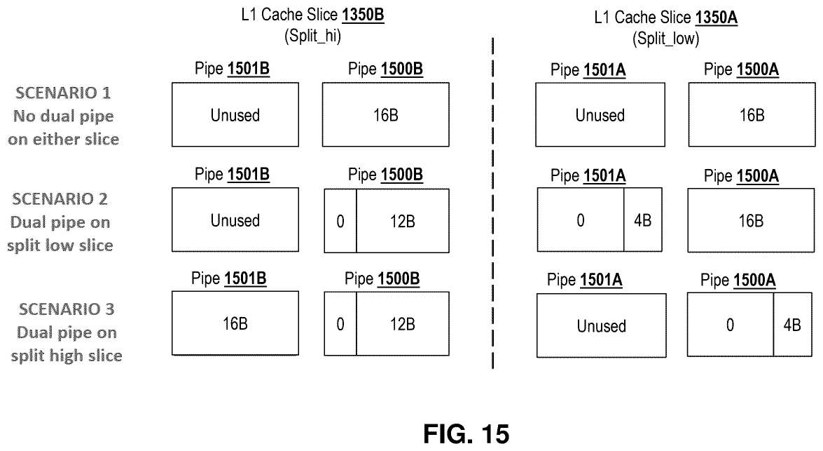

FIG. 15 illustrates three distinct scenarios for a load distributed across a first L1 cache slice 1350A comprising first and second pipes 1500A-1501A and a second L1 cache slice 1350B comprising first and second pipes 1500B-1501B.

In scenario 1, the 256-bit load splits evenly into 128-bits at the split boundary. Each L1 cache slice 1350A-B can complete its respective split half with just one pipe 1500A-B, with each pipe providing 128-bits of the data. The split high rotation amount is adjusted to zero as the split high can simply be appended to the split low data by the aggregator 1420. The aggregator 1420 in this example detects the scenario and places the split high data in the upper 128 bits of the split data register 1470 without ORing it with existing split low data to form the 256-bit data 1490.

In scenario 2, the 256-bit load splits such that the split low in L1 cache slice 1350A includes more than 128 bits of data. As a result, the split low executes over 2 pipes 1500A-B in its respective slice 1350A. Each pipe in the split low slice rotates data right, into the same register alignment as a smaller load. However, the split high data provided in pipe 1500B of L1 cache slice 1350B now needs to be rotated left by the amount of the split low access that falls in the upper 128 bits (e.g., 4 Bytes in the example). Thus, the corresponding rotator (e.g., primary rotator 1402) is dynamically adjusted to rotate by the amount of the upper 128 bits consumed by the split low operation. In one embodiment, the rotation amount is changed to the equivalent of split low size mod 128 bits. Thus, the 12 Bytes shown with respect to pipe 1500B is rotated by 4 Bytes.

In scenario 3, the 256-bit load splits such that the split high contains more than 128-bits—i.e., 16B in pipe 1501B and 12B in pipe 1500B. Consequently, the split high operation executes over the two pipes 1500B, 1501B in its slice 1350B. Typically, the access would be split as the first 128-bits on the primary pipe and the remainder on the secondary pipe. But that poses an issue related to left-shifting the split high data (by the split low size) would need the data beyond the 128-bits to be muxed over to the secondary pipe 1501B. To avoid this complexity, one implementation splits the data between the two split high pipes such that higher 128 bits are handled on the secondary pipe 1501B and the remaining lower bits of split high are handled on the primary pipe 1500B. The data handled by the primary pipe 1500B (i.e., 12 Bytes) is shifted by split low amount as with any regular split load. The aggregator 1420 then ORs the data from the split high primary pipe 1500B with the split low data from pipe 1500A (i.e., 4 Bytes) to complete the lower 128-bits of the 256-bit returned data 1490. The split high data handled by the secondary pipe 1501B (i.e., 16 bytes) is placed directly in the top 128 bits of the split register 1470 to form the entire 256-bit data 1490.

### Aggregation

As mentioned, the aggregator 1420 combines the data from multiple pipes into a relatively larger register 1470 or other storage structure before sending it to the vector execution unit 1325. In some embodiments, new interface circuitry is included to indicate if the data is being returned for a 256-bit load on the half-width bus and if the load was executed in dual-pipe mode so it can be written with the correct alignment in the split registers and/or in the 256-bit data register 1470.

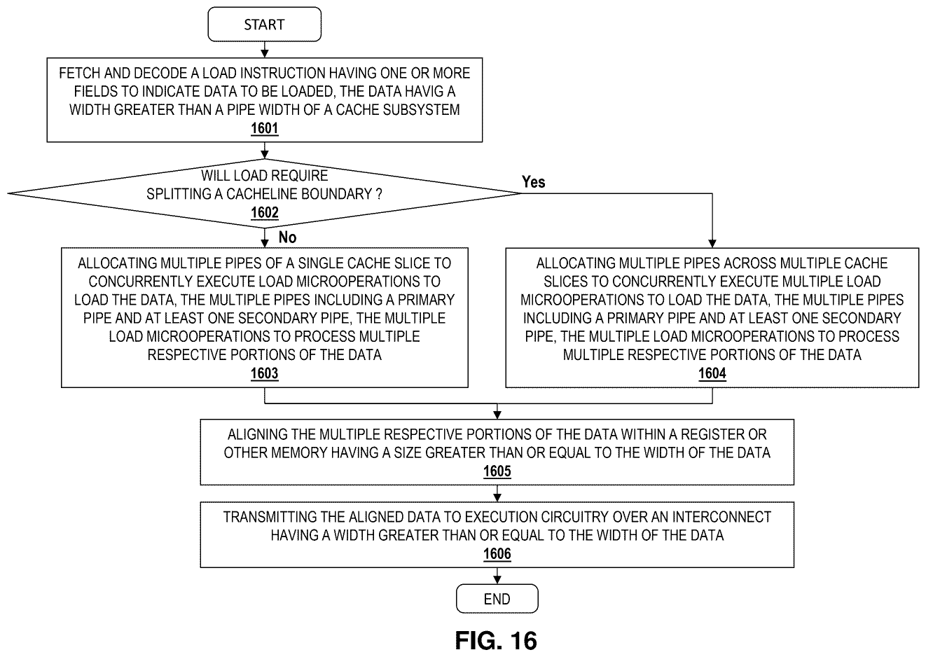

FIG. 16 illustrates a method in accordance with some embodiments of the invention. The method may be implemented on the architectures described herein, but is not limited to any particular processor or system architecture.

At 1601, a vector load instruction having one or more fields to indicate data to be loaded is fetched and decoded. The data of this particular vector load instruction has a width greater than a pipe width of a cache subsystem (e.g., the data buses/interconnects within the L1 cache slices).

At 1602, a determination is made as to whether execution of the vector load instruction will require splitting on a cacheline boundary. As mentioned, in some embodiments, the L1 cache slices 1340A-D may be associated with different sets of addresses, such that two portions of a cacheline split will land in two different L1 slices 1340A-D. In this case, at 1604, multiple pipes are allocated across the multiple slices to concurrently execute multiple load microoperations to load the data, where the multiple pipes include a primary pipe and at least one secondary pipe. The multiple load microoperations process multiple respective portions of the requested data.

If the load will not require splitting of a cacheline boundary, then at 1603, multiple pipes of a single cache slice are allocated to concurrently execute multiple load microoperations to load the data. As in 1604, the multiple pipes include a primary pipe and at least one secondary pipe and the multiple load microoperations process multiple respective portions of the requested data.

At 1605, the multiple respective portions of the data are aligned within a register or other memory having a size greater than or equal to the width of the data. In the embodiments described above, for example, the register 1470 has a size of at least 256 bits to accommodate the maximum load size.

At 1606, the aligned data is transmitted to the requesting execution circuitry (e.g., the vector execution circuitry) over an interconnect having a width which is greater than or equal to the width of the data (e.g., 256 bits in the above-described examples).

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

### EXAMPLES

The following are example implementations of different embodiments of the invention.

Example 1. A processor, comprising: a cache subsystem comprising a plurality of levels of cache memories, at least one level of cache memory to be subdivided into a plurality of cache slices; a front end to fetch and decode a vector load instruction having one or more fields to indicate data to be loaded, the data having a width greater than a data pipe width of the plurality of cache slices; circuitry to allocate multiple data pipes of a single cache slice or across multiple cache slices of the plurality of cache slices, the multiple data pipes to be used to provide multiple respective portions of the data to be loaded; data alignment circuitry to align the multiple respective portions of the data within a register or other memory having a size greater than or equal to the width of the data; and an interconnect to couple the register or other memory to execution circuitry, the interconnect having a width greater than or equal to the width of the data and to be used to provide the data to the execution circuitry responsive to the vector load instruction.

Example 2. The processor of example 1, wherein each data pipe of the multiple data pipes comprise cache interconnects local to the cache subsystem.

Example 3. The processor of examples 1 or 2, wherein a separate microoperation corresponding to the vector load instruction is to be executed to access each portion of the multiple respective portions of the data.

Example 4. The processor of any of examples 1-3, wherein the multiple data pipes are to be allocated from either a single cache slice or across multiple cache slices based on a characteristic of the vector load instruction.

Example 5. The processor of any of examples 1-4, wherein the characteristic comprises the data to be loaded being split across a cache line boundary of different cache slices of the plurality of cache slices.

Example 6. The processor of any of examples 1-5, wherein the at least one level of cache memory comprises a Level 1 (L1) cache memory and the plurality of cache slices comprise a plurality of L1 cache slices.

Example 7. The processor of any of examples 1-6, wherein the multiple data pipes comprise a primary data pipe and at least one secondary data pipe and wherein the data alignment circuitry comprises a primary rotator associated with the primary data pipe and a secondary rotator associated with the secondary data pipe.

Example 8. The processor of any of examples 1-7, wherein external to the cache subsystem, the vector load instruction is to be associated with the primary data pipe.

Example 9. A method, comprising: fetching and decoding a vector load instruction having one or more fields to indicate data to be loaded, the data having a width greater than a data pipe width of a cache subsystem, the cache subsystem comprising a plurality of levels of cache memories, at least one level of cache memory to be subdivided into a plurality of cache slices; allocating multiple data pipes of the cache subsystem to concurrently provide multiple corresponding portions of the data, wherein the multiple data pipes are to be allocated from multiple slices of the plurality of slices or from a single slice of the plurality of slices; aligning the multiple corresponding portions of the data within a register or other memory having a size greater than or equal to the width of the data; and providing the data to execution circuitry over an interconnect having a width greater than or equal to the width of the aligned data.

Example 10. The method of example 9, wherein a separate microoperation corresponding to the vector load instruction is to be executed to access each portion of the multiple corresponding portions of the data.

Example 11. The method of examples 9 or 10, wherein the multiple data pipes are to be allocated from either a single cache slice or across multiple cache slices based on a characteristic of the vector load instruction.

Example 12. The method of any of examples 9-11, wherein the characteristic comprises the data to be loaded being split across a cache line boundary of different cache slices of the plurality of cache slices.

Example 13. The method of any of examples 9-12, wherein the at least one level of cache memory comprises a Level 1 (L1) cache memory and the plurality of cache slices comprise a plurality of L1 cache slices.

Example 14. The method of any of examples 9-13, wherein the multiple data pipes comprise a primary data pipe and at least one secondary data pipe and wherein the data alignment circuitry comprises a primary rotator associated with the primary data pipe and a secondary rotator associated with the secondary data pipe.

Example 15. The method of any of examples 9-14, wherein external to the cache subsystem, the vector load instruction is to be associated with the primary data pipe.

Example 16. A machine-readable medium having program code stored thereon which, when executed by a machine, causes the machine to perform additional operations, comprising: fetching and decoding a vector load instruction having one or more fields to indicate data to be loaded, the data having a width greater than a data pipe width of a cache subsystem, the cache subsystem comprising a plurality of levels of cache memories, at least one level of cache memory to be subdivided into a plurality of cache slices; allocating multiple data pipes of the cache subsystem to concurrently provide multiple corresponding portions of the data, wherein the multiple data pipes are to be allocated from multiple slices of the plurality of slices or from a single slice of the plurality of slices; aligning the multiple corresponding portions of the data within a register or other memory having a size greater than or equal to the width of the data; and providing the data to execution circuitry over an interconnect having a width greater than or equal to the width of the aligned data.

Example 17. The machine-readable medium of example 16, wherein a separate microoperation corresponding to the vector load instruction is to be executed to access each portion of the multiple corresponding portions of the data.

Example 18. The machine-readable medium of examples 16 or 17, wherein the multiple data pipes are to be allocated from either a single cache slice or across multiple cache slices based on a characteristic of the vector load instruction.

Example 19. The machine-readable medium of any of examples 16-18, wherein the characteristic comprises the data to be loaded being split across a cache line boundary of different cache slices of the plurality of cache slices.

Example 20. The machine-readable medium of any of examples 16-19, wherein the at least one level of cache memory comprises a Level 1 (L1) cache memory and the plurality of cache slices comprise a plurality of L1 cache slices.

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
a cache subsystem comprising a plurality of levels of cache memories, at least one level of cache memory to be subdivided into a plurality of cache slices;
a front end to fetch and decode a vector load instruction having one or more fields to indicate data to be loaded, the data having a width greater than a data pipe width of the plurality of cache slices;
circuitry to allocate multiple data pipes of a single cache slice or across multiple cache slices of the plurality of cache slices, the multiple data pipes to be used to provide multiple respective portions of the data to be loaded;
data alignment circuitry to align the multiple respective portions of the data within a register or other memory having a size greater than or equal to the width of the data; and
an interconnect to couple the register or other memory to execution circuitry, the interconnect having a width greater than or equal to the width of the data and to be used to provide the data to the execution circuitry responsive to the vector load instruction.

2. The processor of claim 1, wherein each data pipe of the multiple data pipes comprise cache interconnects local to the cache subsystem.

3. The processor of claim 2, wherein a separate microoperation corresponding to the vector load instruction is to be executed to access each portion of the multiple respective portions of the data.

4. The processor of claim 1, wherein the multiple data pipes are to be allocated from either a single cache slice or across multiple cache slices based on a characteristic of the vector load instruction.

5. The processor of claim 4, wherein the characteristic comprises the data to be loaded being split across a cache line boundary of different cache slices of the plurality of cache slices.

6. The processor of claim 1, wherein the at least one level of cache memory comprises a Level 1 (L1) cache memory and the plurality of cache slices comprise a plurality of L1 cache slices.

7. The processor of claim 1, wherein the multiple data pipes comprise a primary data pipe and at least one secondary data pipe and wherein the data alignment circuitry comprises a primary rotator associated with the primary data pipe and a secondary rotator associated with the secondary data pipe.

8. The processor of claim 7, wherein external to the cache subsystem, the vector load instruction is to be associated with the primary data pipe.

9. A method, comprising:
fetching and decoding a vector load instruction having one or more fields to indicate data to be loaded, the data having a width greater than a data pipe width of a cache subsystem, the cache subsystem comprising a plurality of levels of cache memories, at least one level of cache memory to be subdivided into a plurality of cache slices;
allocating multiple data pipes of the cache subsystem to concurrently provide multiple corresponding portions of the data, wherein the multiple data pipes are to be allocated from multiple slices of the plurality of slices or from a single slice of the plurality of slices;
aligning the multiple corresponding portions of the data within a register or other memory having a size greater than or equal to the width of the data; and
providing the data to execution circuitry over an interconnect having a width greater than or equal to the width of the aligned data.

10. The method of claim 9, wherein a separate microoperation corresponding to the vector load instruction is to be executed to access each portion of the multiple corresponding portions of the data.

11. The method of claim 9, wherein the multiple data pipes are to be allocated from either a single cache slice or across multiple cache slices based on a characteristic of the vector load instruction.

12. The method of claim 11, wherein the characteristic comprises the data to be loaded being split across a cache line boundary of different cache slices of the plurality of cache slices.

13. The method of claim 9, wherein the at least one level of cache memory comprises a Level 1 (L1) cache memory and the plurality of cache slices comprise a plurality of L1 cache slices.

14. The method of claim 9, wherein the multiple data pipes comprise a primary data pipe and at least one secondary data pipe and wherein the data alignment circuitry comprises a primary rotator associated with the primary data pipe and a secondary rotator associated with the secondary data pipe.

15. The method of claim 14, wherein external to the cache subsystem, the vector load instruction is to be associated with the primary data pipe.

16. A machine-readable medium having program code stored thereon which, when executed by a machine, causes the machine to perform additional operations, comprising:
fetching and decoding a vector load instruction having one or more fields to indicate data to be loaded, the data having a width greater than a data pipe width of a cache subsystem, the cache subsystem comprising a plurality of levels of cache memories, at least one level of cache memory to be subdivided into a plurality of cache slices;
allocating multiple data pipes of the cache subsystem to concurrently provide multiple corresponding portions of the data, wherein the multiple data pipes are to be allocated from multiple slices of the plurality of slices or from a single slice of the plurality of slices;
aligning the multiple corresponding portions of the data within a register or other memory having a size greater than or equal to the width of the data; and
providing the data to execution circuitry over an interconnect having a width greater than or equal to the width of the aligned data.

17. The machine-readable medium of claim 16, wherein a separate microoperation corresponding to the vector load instruction is to be executed to access each portion of the multiple corresponding portions of the data.

18. The machine-readable medium of claim 16, wherein the multiple data pipes are to be allocated from either a single cache slice or across multiple cache slices based on a characteristic of the vector load instruction.

19. The machine-readable medium of claim 18, wherein the characteristic comprises the data to be loaded being split across a cache line boundary of different cache slices of the plurality of cache slices.

20. The machine-readable medium of claim 16, wherein the at least one level of cache memory comprises a Level 1 (L1) cache memory and the plurality of cache slices comprise a plurality of L1 cache slices.
